(19) United States
(12) Patent Application Publication
(10) Pub. No.: US 2024/0178524 A1
(43) Pub. Date: May 30, 2024

(54) BATTERY CELL ASSEMBLY

(71) Applicant: Dr. Ing. h.c. F. Porsche Aktiengesellschaft, Stuttgart (DE)

(72) Inventors: Tim Schmidt, Freiberg am Neckar (DE); Dominik Grass, Bietigheim-Bissingen (DE)

(73) Assignee: Dr. Ing. h.c. F. Porsche Aktiengesellschaft, Stuttgart (DE)

(21) Appl. No.: 18/388,600

(22) Filed: Nov. 10, 2023

(30) Foreign Application Priority Data
Nov. 25, 2022 (DE) 10 2022 131 200.3

(51) Int. Cl. H01M 50/503; H01M 50/516; H01M 50/522; H01M 50/548

(52) U.S. Cl. CPC H01M 50/503; H01M 50/516; H01M 50/522; H01M 50/548; H01M 2220/20

(57) ABSTRACT

A battery cell assembly includes a plurality of battery cells, wherein the battery cells each include at least one first cell connecting element and at least one second cell connecting element. The cell connecting elements of the battery cells are each disposed on the end face side of the battery cells. Battery cells disposed in pairs are disposed opposite to a respective cell connecting element. An electrically conductive bracket is fastened at least to the oppositely disposed cell connecting elements as a cell connector. The first bracket of a first battery cell of the battery cells disposed in pairs surrounds and makes electrically conductive contact with the second bracket of the opposite second battery cell of the battery cells disposed in pairs.

### CROSS-REFERENCE TO RELATED APPLICATION

This application claims priority to German Patent Application No. 10 2022 131 200.3, filed Nov. 25, 2022, the content of such application being incorporated by reference herein in its entirety.

### FIELD OF THE INVENTION

The invention relates to a battery device and a battery cell assembly for a battery device, in particular for an electrically driven motor vehicle.

### BACKGROUND OF THE INVENTION

Motor vehicles with electric drive are well known. Such motor vehicles have a battery-electric drive or a hybrid drive with a battery-electric drive and an internal combustion engine, for example. The battery-electric drive comprises a high-voltage battery device as the battery device and an electric drive motor that is powered by the high-voltage battery device. Such high-voltage battery devices typically have at least one battery cell assembly comprising a plurality of battery cells, which are, for example, disposed in one or more battery cell stacks in the housing of the high-voltage battery device.

The battery cells each comprise at least one first cell connecting element and at least one second cell connecting element, wherein a plurality of such battery cells in a battery cell assembly are connected to one another and/or to connecting elements of the battery cell assembly by means of cell connectors.

A variety of different cell connectors have become known in the prior art, which altogether are either too costly to manufacture and/or too cumbersome to assemble. DE 10 2013 225 340 A1, which is incorporated by reference herein, for instance, discloses cell connectors that are connected to a contacting portion of a cell connecting element by means of a plug connection. This requires the production of both the cell connector and the cell connecting element to be correspondingly complex in order for the plug connection to be reliable and permanent. This increases the costs, so that such plug connections are rather undesirable.

DE 10 2016 106 171 A1, which is incorporated by reference herein, discloses an arrangement of battery cells that are disposed side by side. The battery cells are connected to one another with a rail. For this purpose, the respective battery cell is grooved in its connection region, wherein a correspondingly complementarily shaped rail is laid transversely across the connection regions of two adjacent battery cells, wherein pins which engage in the openings of the rail are provided as connecting elements. Such a design is fundamentally complicated and costly, wherein such an arrangement is also only suitable if the battery cells to be connected are disposed directly adjacent to one another. Such a design is therefore also not suitable for every battery cell assembly.

### SUMMARY OF THE INVENTION

Described herein is a battery cell assembly and a battery device that is constricted in a cost-effective manner and enables a reliable electrical connection of the battery cells.

An exemplary embodiment of the invention relates to a battery cell assembly comprising a plurality of battery cells, wherein the battery cells each comprise at least one first cell connecting element and at least one second cell connecting element, wherein the cell connecting elements of the battery cells are each disposed on the end face side of the battery cells, wherein battery cells disposed in pairs are disposed opposite to a respective cell connecting element, wherein an electrically conductive bracket is fastened at least to the oppositely disposed cell connecting elements as a cell connector, wherein the first bracket of a first battery cell of the battery cells disposed in pairs surrounds and makes electrically conductive contact with the second bracket of the opposite second battery cell of the battery cells disposed in pairs. This makes it possible to achieve stable and permanent and reliable contact that is also easy to produce.

It is also expedient if the first bracket is substantially U-shaped with a central region and arms which project from it at the respective ends and the second bracket is substantially U-shaped with a central region and arms which project from it at the respective ends, wherein the arms of the first bracket extend over the arms of the second bracket. This ensures that the connection can be established quickly and easily and the costs are low.

It is also expedient if the projecting arms of the second brackets are U-shaped, in particular bent back. This creates a resilient design that promotes loading of the arms.

It is also expedient if the projecting arms of the first bracket touch the projecting arms of the second bracket, wherein the projecting arms of the first bracket pretension the projecting arms of the second bracket and/or the projecting arms of the second bracket pretension the projecting arms of the first bracket. This ensures that the electrical connection is reliable. This produces a good fit and also a tolerance compensation.

In another example embodiment, it is expedient if the projecting arms of the first bracket touch the projecting arms of the second bracket, wherein the contact area is free of air gaps. This ensures a safe process during welding.

It is also expedient if the brackets are made of metal, in particular metal sheet. This results in a cost-effective solution that is also easy to produce.

It is also advantageous if the brackets are connected to the cell connecting elements in a materially bonded manner, in particular welded, for example laser-welded. This ensures a reliable, permanent electrical and mechanical connection.

It is also expedient if the arms of the first bracket are connected to the arms of the second bracket in a materially bonded manner, in particular welded, for example laser-welded. This ensures a reliable, permanent electrical and mechanical connection.

It is also advantageous if the arms comprise free ends, wherein the free ends of the arms of the first bracket are curved and/or the free ends of the arms of the second bracket are curved. This ensures that a secure connection is achieved when the brackets are pushed together.

An example embodiment of the invention relates to a battery device comprising a battery cell assembly according to the present invention.

### BRIEF DESCRIPTION OF THE DRAWINGS

The invention will be described in detail in the following using example embodiments with reference to the drawings. The drawings show:

FIG. 1 is a schematic illustration of a first example embodiment of a battery cell assembly according to aspects of the invention in a not yet coupled state,

FIG. 2 is a schematic illustration of the first example embodiment of the battery cell assembly according to aspects of the invention in a coupled state,

FIG. 3 is a schematic illustration of a second example embodiment of a battery cell assembly according to aspects of the invention in a not yet coupled state, and

FIG. 4 is a schematic illustration of the second example embodiment of the battery cell assembly according to aspects of the invention in a coupled state.

### DETAILED DESCRIPTION OF THE INVENTION

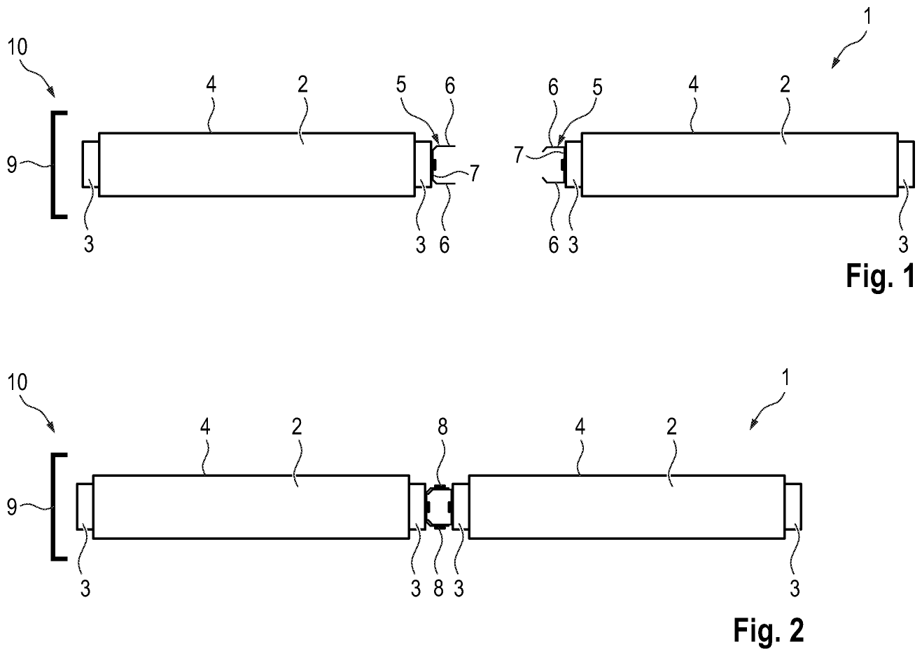

FIG. 1 shows in a schematic illustration a first example embodiment of a battery cell assembly 1 according to aspects of the invention in a not yet coupled state, wherein FIG. 2 shows the battery cell assembly 1 according to FIG. 1 in a coupled state.

The battery cell assembly 1 comprises a plurality of battery cells 2. Only two battery cells 2 are shown in FIGS. 1 and 2 to explain the idea of the invention.

The battery cells 2 are embodied as prismatic battery cells as an example. However, the configuration of the battery cells 2 could also be different, for example round cells, coffee bag cells, etc.

The battery cells 2 each comprise at least one first cell connecting element 3 and at least one second cell connecting element 3.

In the shown example embodiment, the cell connecting elements 3 of the battery cells 2 are each disposed on the end face side of the battery cells 2. These cell connecting elements 3 extend from the housing 4 of the battery cell 2, for example, and project from the end face.

According to FIG. 1, the battery cells 2 are disposed in pairs, wherein the battery cells 2 are disposed opposite to a respective cell connecting element 3.

For the electrical and mechanical connection of the two opposite battery cells 2, an electrically conductive bracket 5 is fastened to the oppositely disposed cell connecting elements 3 as a cell connector. The electrically conductive brackets 5 are connected to the cell connecting element 3 in an electrically conductive manner.

In the shown example embodiment, the brackets 5 are made of metal, in particular metal sheet. The brackets 5 can be made of a steel sheet, an aluminum sheet, etc.

The brackets 5 are connected to the respective cell connecting element 3 in a materially bonded manner; for example; the brackets 5 are in particular welded to the cell connecting elements 3, for example laser-welded. A form-locking connection can alternatively or additionally be provided as well.

According to FIG. 2, the first bracket 5 of a first battery cell 2 of the battery cells 2 disposed in pairs extends over and makes electrically conductive contact with the second bracket 5 of the opposite second battery cell 2 of the battery cells 2 disposed in pairs. In FIG. 2, the left bracket 5 extends over the right bracket 5.

From FIGS. 1 and 2 it can also be seen that the first bracket 5 is substantially U-shaped with a central region 7 and arms 6 which project from it at the respective ends and the second bracket 5 is also substantially U-shaped with a central region 7 and arms 6 which project from it at the respective ends. The arms 6 of the first bracket extend over the arms 6 of the second bracket 5.

It is particularly advantageous if the projecting arms 6 of the first bracket 5 touch the projecting arms 6 of the second bracket 5 in order to create the electrical contact, and it is also expedient, for example, if the projecting arms 6 of the first bracket 5 pretension the projecting arms 6 of the second bracket 5 and/or the projecting arms 6 of the second bracket 5 pretension the projecting arms 6 of the first bracket 5.

This makes it possible to achieve that the projecting arms 6 of the first bracket 5 touch the projecting arms 6 of the second bracket 5, wherein the contact area is free of air gaps.

It is also advantageous if the arms 6 of the first bracket 5 are connected to the arms 6 of the second bracket 5 in a materially bonded manner, in particular welded, for example laser-welded, see FIG. 2, which shows a weld connection 8.

It is also advantageous if the arms 6 comprise free ends, wherein the free ends of the arms 6 of the first bracket 5 are curved and/or the free ends of the arms 6 of the second bracket are curved. This makes it easier to push the brackets 5 of the two battery cells 2 together.

The housing 9 of the battery device 10, in which the battery cell assembly 1 is disposed, can be seen as well.

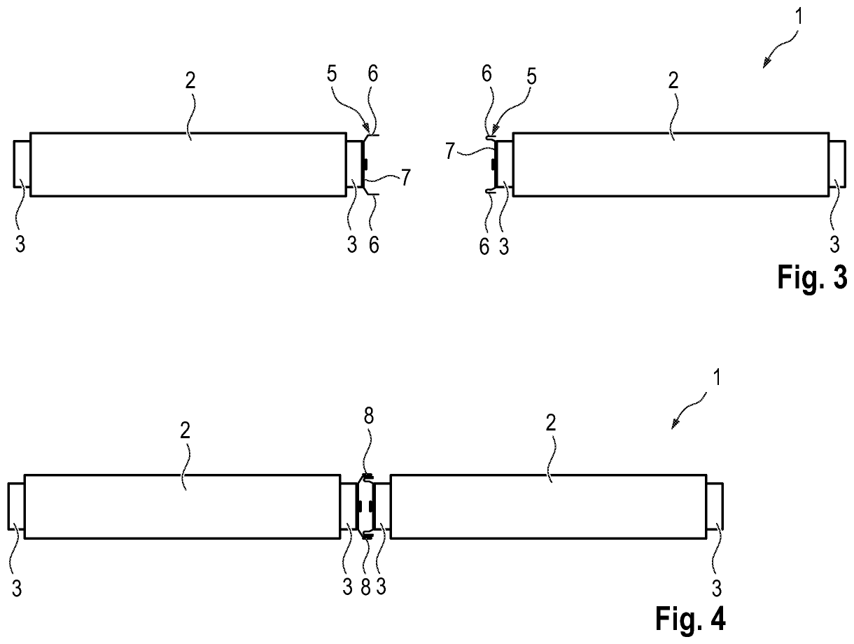

The second example embodiment of FIGS. 3 and 4 differs from the first example embodiment of FIGS. 1 and 2 in the configuration of the second bracket 5. Otherwise, reference is made to the description of FIGS. 1 and 2.

In FIGS. 3 and 4 it can be seen that the projecting arms 6 of the second bracket 5 are U-shaped, in particular, bent back. This creates a spring effect for the arms 6.

### LIST OF REFERENCE SIGNS

1 Battery cell assembly
2 Battery cell
3 Cell connecting element
4 Housing
5 Bracket
6 Arms
7 Central region
8 Weld connection
9 Housing
10 Battery device

What is claimed is:

1. A battery cell assembly comprising:
a pair of battery cells including a first battery cell and a second battery cell, wherein each battery cell comprises at least one first cell connecting element and at least one second cell connecting element, wherein the cell connecting elements of each battery cell are disposed on end face sides of the respective battery cell, wherein each battery cell of the pair of battery cells is disposed opposite to one of the cell connecting element of another battery cell of the pair of battery cells; and
an electrically conductive bracket arrangement in the form of a cell connector that is fastened at least to oppositely disposed cell connecting elements of the pair of battery cells, wherein the electrically conductive bracket arrangement comprises a first bracket connected to the first battery cell and a second bracket connected to the second battery cell, wherein the first bracket surrounds and makes electrically conductive contact with the second bracket.

2. The battery cell assembly according to claim 1, wherein each bracket is substantially U-shaped with a central region and projecting arms which project from the central region at respective ends of the central region, wherein the projecting arms of the first bracket extend over the projecting arms of the second bracket.

3. The battery cell assembly according to claim 2, wherein the projecting arms of the second bracket are bent towards each other.

4. The battery cell assembly according to claim 2, wherein the projecting arms of the first bracket contact the projecting arms of the second bracket, wherein the projecting arms of the first bracket pretension the projecting arms of the second bracket and/or the projecting arms of the second bracket pretension the projecting arms of the first bracket.

5. The battery cell assembly according to claim 4, wherein the projecting arms of the first bracket contact the projecting arms of the second bracket at a contact area, wherein the contact area is free of air gaps.

6. The battery cell assembly according to claim 1, wherein the brackets are composed of metal or sheet metal.

7. The battery cell assembly according to claim 1, wherein the brackets are connected to the cell connecting elements in a materially bonded manner.

8. The battery cell assembly according to claim 7, wherein the brackets are welded together.

9. The battery cell assembly according to claim 7, wherein the brackets are laser-welded together.

10. The battery cell assembly according to claim 1, wherein each bracket is substantially U-shaped with a central region and projecting arms which project from the central region at respective ends of the central region, and wherein the projecting arms of the first bracket are connected to the arms of the second bracket in a materially bonded manner, by welding, or by laser-welded.

11. The battery cell assembly according to claim 10, wherein the arms comprise free ends, wherein the free ends of the arms of the first bracket are curved and/or the free ends of the arms of the second bracket are curved.

12. A battery device comprising the battery cell assembly according to claim 1.

13. An electrically driven motor vehicle comprising the battery device of claim 12.
